(19) United States
(12) Patent Application Publication
(10) Pub. No.: US 2010/0164731 A1
(43) Pub. Date: Jul. 1, 2010

(54) Method and apparatus for media viewer health care

(76) Inventor: Aiguo Xie, Sunnyvale, CA (US)

Correspondence Address: Aiguo Xie, 825 Maria Lane, #658, Sunnyvale, CA, 94086, US

(21) Appl. No.: 12/653,990

(22) Filed: Dec. 22, 2009

Related U.S. Application Data
(60) Provisional application No. 61/203,900, filed on Dec. 29, 2008.

(51) Int. Cl. G08B 23/00; H04N 7/18; G06K 9/00

(52) U.S. Cl. 340/573.1; 348/77; 382/128; 348/E07.085

(57) ABSTRACT

A method and apparatus are provided for evaluating viewing behaviors of media viewers. The viewing space of the media is imaged and analyzed to detect media viewers and evaluate their viewing behaviors using machine vision. Based on their evaluated viewing behaviors, a health care feature may be delivered to the media viewers.

### REFERENCES DOCUMENTS CITED

### U.S. Patent Documents Cited

| | | |
|---|---|---|
| 5,168,264 | Dec. 1, 1992 | Decreton; B., et al. |
| 6,097,309 | Aug. 1, 2000 | Hayes; P. H., et al. |
| 6,301,370 | Oct. 9, 2001 | Steffens; J. B., et al. |
| 6,325,508 | Dec. 4, 2001 | Agustin; H. |
| 7,098,772 | Aug. 29, 2006 | Cohen; R. S. |
| 7,343,615 | Mar. 11, 2008 | Nelson; D. J., et al. |
| 7,362,213 | Apr. 22, 2008 | Cohen; R. S. |

### Other References Cited

Mohan, et al., “Example-based object detection in images by components,” IEEE Trans. on Pattern Analysis and Machine Intelligence, Vol. 23, No. 4, pp. 349-361, April 2001.
Viola, et al., “Rapid object detection using a boosted cascade of simple features,” Proc. IEEE Conf. on Computer Vision and Pattern Recognition, December 2001.
Ronfard, et al., “Learning to parse pictures of people,” Proc. 7th European Conf. on Computer Vision, Part IV, pp. 700-714, June 2002.
Mikolajczyk, et al., “Human detection based on a probabilistic assembly of robust part detectors,” Proc. 8th European Conference on Computer Vision, Vol. I, pp. 69-81, May 2004.
Yang, et al., “Detecting faces in images: A survey,” IEEE Trans. on Pattern Analysis and Machine Intelligence, Vol. 24, No. 1, pp. 34-58, January 2002.
Sung, et al., “Example-based learning for view-based human face detection,” IEEE Trans. on Pattern Analysis and Machine Intelligence, Vol. 20, No. 1, pp. 39-51, January 1998.
Keren, et al., “Antifaces: A novel fast method for image detection,” IEEE Trans. on Pattern Analysis and Machine Intelligence, Vol. 23, No. 7, pp. 747-761, July 2001.
Viola, et al., “Robust real-time face detection,” Int'l J. of Computer Vision, Vol. 57, No. 2, pp. 137-154, May 2004.
Osadchy, et al., “Synergistic face detection and pose estimation with energy-based models,” J. of Machine Learning Research, Vol. 8, pp. 1197-1214, May 2007.
Hiesele, et al., “A component-based framework for face detection and identification,” Int'l J. of Computer Vision, Vol. 74, No. 2, pp. 167-181, August 2007.
Murphy-Chutorian, et al., “Head Pose Estimation in Computer Vision: A Survey,” IEEE Trans. on Pattern Analysis and Machine Intelligence, PrePrints, April 2008.
Kruger, et al., “Determination of face position and pose with a learned representation based on labeled graphs,” Image and Vision Computing, Vol. 15, No. 8, pp. 665-673, August 1997.
Huang, et al., “Face pose discrimination using support vector machines (SVM),” Proc. Int'l. Conf. Pattern Recognition, pp. 154-156, August 1998.
Matsumoto, et al., “An algorithm for real-time stereo vision implementation of head pose and gaze direction measurement,” Proc. IEEE 4th Int. Conf. on Automatic Face and Gesture Recognition, pp. 499-504, March 2000.
Sherrah, et al., “Face distributions in similarity space under varying head pose,” Image and Vision Computing, Vol. 19, No. 12, pp. 807-819, December 2001.
Moon, et al., “Estimating facial pose from a sparse representation,” Proc. Int'l Conf. on Image Processing, pp. 75-78, October 2004.
Lam, et al., “Locating and extracting the eye in human face images,” Pattern Recognition, Vol. 29, No. 5, pp. 771-779, May 1996.
Huang, et al., “Eye detection using optimal wavelet packets and radial basis functions,” J. of Pattern Recognition and Artificial Intelligence, Vol. 13, No. 7, pp. 1009-1025, July 1999.
Sirohey, et al., “Eye detection in a face image using linear and nonlinear filters,” Pattern Recognition, Vol. 34, No. 7, pp. 1367-1391, July 2001.
Peng, et al., “A Robust and Efficient Algorithm for Eye Detection on Gray Intensity Face,” J. of Computer Science and Technology, Vol. 5, No. 3, pp. 127-132, October 2005.
Teutsch, “Model-based analysis and evaluation of point sets from optical 3D laser scanners,” Ph.D. Thesis, Shaker Verlag, ISBN: 978-3-8322-6775-9, 2007.
Papageorgiou, et al., “A trainable system for object detection,” Int'l. J. of Computer Vision, Vol. 38, No. 1, pp. 15-33, June 2000.
Viola, et al., “Robust real-time object detection,” Int'l J. of Computer Vision, Vol. 57, No. 2, pp. 137-154, May 2004.
Bochard, et al., “A hierarchical part-based model for visual object categorization,” Proc. IEEE Int'l Conf. on Computer Vision and Pattern Recognition, pp. 710-715, June 2005.
Fergus, et al., “A sparse object category model for efficient learning and exhaustive recognition,” Proc. IEEE Int'l Conf. on Computer Vision and Pattern Recognition, pp. 710-715, June 2005.
Daugman, “High confidence visual recognition of persons by a test of statistical independence,” IEEE Trans. on Pattern Recognition and Machine Intelligence, Vol. 15, No. 11, pp. 1148-1161, November 1993.
Tan, et al., “Appearance-based eye gaze estimation,” Proc. 6th IEEE Workshop on Applications of Computer Vision, pp. 191-195, December 2002.
Taylor, “Reconstruction of articulated objects from point correspondences in a single uncalibrated image,” Computer Vision and Image Understanding, Vol. 80, No. 3, pp. 349-363, December 2000.
Mori, et al., “Estimating human body configurations using shape context matching,” Proc. 7th European Conf. on Computer Vision, Part III, pp. 660-668, June 2002.
Sigal, et al. “Measure locally, reason globally: Occlusion-sensitive articulated pose estimation,” Proc. IEEE Conf. on Computer Vision and Pattern Recognition, pp. 2041-2048, June 2006.
Zhao, et al., “Face recognition: A literature survey,” ACM Computing Surveys, Vol. 35, No. 4, pp. 399-458, December 2003.
Wren, et al., “Pfinder: real-time tracking of the human body,” IEEE Trans. on Pattern Analysis and Machine Intelligence, Vol. 19, No. 7, pp. 780-785, July 1997.
Zhou, et al., “Real time robust human detection and tracking system,” Proc. IEEE Conf. on Computer Vision and Pattern Recognition, Vol. 3, pp. 149-149, June 2005.
Fu, et al., “Image-based human age estimation by manifold learning and locally adjusted robust regression,” IEEE Trans. on Image Processing, Vol. 17, No. 7, pp. 1178-1188, July 2008.
Mkolajczyk, et al., “Face detection in a video sequence—a temporal approach,” Proc. IEEE Conf. on Computer Vision and Pattern Recognition, Vol. II., pp. 96-101, December 2001.
Froba, et al., “Face Tracking by Means of Continuous Detection,” Proc. CVPR Workshop on Face Processing in Video, pp. 65-66, June 2004.
Gorodnichy, “Seeing faces in video by computers. Editorial for Special Issue on Face Processing in Video Sequences,” Image and Vision Computing, Vol. 24, No. 6, pp. 551-556, June 2006.
Morency, et al., “Fast stereo-based head tracking for interactive environments,” Proc. Int'l. Conf. Automatic Face and Gesture Recognition, pp. 375-380, May 2002.
Huang, et al., “Robust Real-Time Detection, Tracking, and Pose Estimation of Faces in Video Streams,” Proc. IEEE Int'l Conf. Pattern Recognition, pp. 965-968, August 2004.
Oka, et al., “Head pose estimation system based on particle filtering with adaptive diffusion control,” Proc. Int'l Conf. on Machine Vision Applications, pp. 586-589, May 2005.
Stiefelhagen, et al., “Tracking eyes and monitoring eye gaze,” Proc. Workshop on Perceptual User Interfaces, pp. 98-100, October 1997.
Bakic, et al., “Real-time tracking of face feature and gaze direction determination,” Proc. 4th IEEE Workshop on Applications of Computer Vision, pp. 256-257, October 1998.
Gorodnichy, “Video-based framework for face recognition,” Proc. 2nd Workshop on Face Processing in Video within 2nd Canadian Conf. on Computer and Robot Vision, pp. 330-338, May 2005.
Reeves, et al., “Identification of three-dimensional objects using range information,” IEEE Trans. on Pattern Analysis and Machine Intelligence, pp. 403-410, Vol. 11, No. 4, April 1989.
Adelson, et al., “Single lens stereo with plensoptic camera,” IEEE Trans. on Pattern Analysis and Machine Intelligence, Vol. 12, No. 2, pp. 99-106, February 1992.
Saxena, et al., “Depth estimation using monocular and stereo cues,” Proc. Int'l Joint Conf. on Artificial Intelligence, pp. 2197-2203, January 2007.
Lange, et al., “Solid state time-of-flight range camera,” IEEE J. of Quantum Electronics, Val. 37, No. 3, pp. 390-397, March 2001.
Oggier, et al., “An all-solid-state optical range camera for 3D real-time imaging with sub-centimeter depth resolution (SwissRanger),” Proc. SPIE, Vol. 5249, pp. 534-545, February 2004.
Eveland, et al., “Tracking human faces in infrared video,” Image and Vision Computing, Vol. 21, No. 7, pp. 579-590, July 2003.
Dowdall, et al., “Face detection in the near-IR spectrum,” Image and Vision Computing, Vol. 21, No. 7, pp. 565-578, July 2003.
Socolinsky, et al., “Face recognition with visible and thermal infrared imagery,” Computer Vision and Image Understanding, Vol. 91, No. 1-2, pp. 72-114, July-August 2003.
Kong, et al. “Recent advances in visual and infrared face recognition: A review,” Computer Vision and Image Understanding, Vol. 97, No. 1, pp. 103-135, January 2005.
Trivedi, Cheng, et al., “Occupant posture analysis with stereo and thermal infrared video: algorithms and experimental evaluation,” IEEE Trans. on Vehicular Technology, Special Issue on In-Vehicle Vision Systems, Vol. 53, No. 6, pp. 1698-1712, November 2004.
Chou, et al., “Toward face detection, pose estimation and human recognition from hyperspectral imagery,” Technical Report NCSA-ALG04-0005, Univ. of Illinois at Urbana Champion, October 2004.

### FIELD OF THE INVENTION

This invention relates to providing health protection to viewers of information bearing media such as books, television sets, computer monitor screens and gaming devices. More particularly, it relates to evaluating the viewing behaviors of media viewers and enforcing appropriate media viewing policies.

### SUMMARY OF THE INVENTION

A method and apparatus are provided for evaluating viewing behaviors of media viewers. The viewing space of the media is imaged and analyzed to detect media viewers and evaluate their viewing behaviors using machine vision. Based on their evaluated viewing behaviors, a health care feature may be delivered to the media viewers.

According to one embodiment of the invention, a media viewer behavior evaluation system analyzes viewing behaviors comprising one or more of viewing duration, eye-to-media distance, body posture and room lighting. According to another embodiment, a media viewer health care system enforces a number of viewing policies each comprising a rule on viewing behaviors and an action based on evaluated viewing behaviors of media viewers. A rule generally concerns with specific healthy viewing behaviors. For example, a distance rule requires a viewer be away from a television screen at least four times the diagonal width of the screen. A policy may be penalizing for which the system executes the respective action when a viewer violates the respective rule. Similarly a policy may be rewarding for which the system executes the respective action which a viewer obeys by the respective rule.

According to another embodiment of the invention, a media viewer behavior evaluation system may analyze the viewing behaviors of individual viewers on multiple media. In another embodiment, a media viewer health care system may enforce a number of viewing policies concerning the viewing behaviors of the viewers on multiple media.

A more complete understanding of the invention and its further viewing behavior evaluation and health care features and advantages can be obtained by reference to the following detailed description and drawings.

### BACKGROUND OF THE INVENTION

Until recently, paper sheets were the most prevalent information bearing media. Textbooks, story books, homework papers and newspapers are some of the common examples. It is well known that improper habits and conditions of reading and writing on paper sheets may develop into serious health problems, especially among children. For example, insufficient distance between eyes and the paper sheets, prolonged reading and writing and inadequate room lightening can all develop into myopia. Improper posture during reading and writing can result in kyphosis, characterized by a bowed back, and scoliosis, characterized by a side-curved or even rotated spine.

Recently, information bearing media has expanded dramatically. Popular modern media examples are television (TV) screens, personal computer (PC) monitors, game consoles and other portable devices. Modern media have become part of everyday life for an increasing population worldwide. Similar to reading and writing on paper sheets, studies conclude that improper viewing habits and conditions on modern media can also develop into serious health problems. Among the most frequently cited are myopia, obesity, neck and back deformation and pain and overall fatigue.

School children often have heavy reading and writing assignments. They are traditionally most susceptible to health problems due to improper reading and writing habits. Today, with the flood of TV programs, web contents and video games, they have an even higher potential to develop into health problems due to improper media viewing habits.

Modern media have also reached preschool children. There are numerous TV programs and gaming devices target them. They have a least degree of self-awareness and yet are most adaptable. They assume what they see and how they see is normal. Besides, their vision and physical body undergo the most important development stage. Without proper media viewing guidance, they may quickly develop health problems such as myopia and physical deformation.

On the other end of the population spectrum, more adults use PCs at work and home nowadays. Studies also show that adult media users tend to have improper viewing habits as well. Insufficient eye-to-media distance, improper head and shoulder posture and prolonged viewing duration are common problems for adults. These lead to sore eyes, neck and back pains, weak muscles and fatigue over time.

Obviously, it is important for people across all ages to have a good habit in media viewing. As the media viewing population continue to increase, some assistance to help develop and maintain a good viewing habit is more urgent than ever.

Ideally, such assistance should be convenient, effective and inexpensive. It should be capable of automatically tracking one or more people, their viewing duration, viewing distance and posture. Also, it is desirable to keep individual viewing behavior history, and enforce appropriate viewing policies applicable to specific age groups or individuals when necessary.

As the prior arts relevant to the present invention, there have been a range of efforts in providing such assistance. They broadly fall into three categories, targeting three popular types of media, namely paper sheets, TV screens and PC screens.

For reading and writing on the traditional paper media, existing efforts have focused on helping maintain proper sitting posture and necessary eye-to-paper distance. Exemplary of these prior arts are U.S. Pat. Nos. 5,168,264 and 6,325,508. These methods require viewers to bear certain devices on their bodies or to be separated from the paper by a physical barrier. They lack convenience and thus are not widely adopted.

For viewing programs on TV screens, existing efforts have focused on restricting the types of programs an individual may watch. An example is a 1996 U.S. legislation cited herein as V-Chip Legislation. Based on this legislation, the Federal Communications Commission (FCC) requires all TV sets made after Jan. 1, 2000 with a screen 13 inches or larger must incorporate the V-Chip feature. This allows parents to block television programming that they do not want their children to watch by programming the V-chip in the TV set.

More recently, there have been efforts on restricting the amount of time a TV set may be turned on for each user account during a specific time period. Exemplary of these efforts are U.S. Pat. Nos. 7,098,772 and 7,362,213. The methods described therein adds a switch between the TV set and power jacket. The switch may be activated if the account of a viewer has viewing time quota remaining. A nearby PC maintains the account and controls the switch via wireless signal transmission. The methods described therein may also be used to control usage time on other devices such as game consoles.

Whereas these methods limits viewer's viewing time, they are not always effective because their tracking may not be accurate. For example, viewer A is free to watch TV without losing any viewing time quota if it is viewer B who activates the switch. Here, the viewing time of viewer A is under-counted. The more the viewers there are in the family, the less effective these methods can be.

As an even more serious problem, these methods can over-count the viewing time of a viewer. They count every second towards the total viewing time of the viewer as long as the TV set is turned on, even if the viewer temporarily walks away. This inevitably discourages the viewer from taking regular breaks to avoid being over-counted for viewing time, which endangers the viewer's health over time.

For viewing on PC screens, existing efforts use software means to restrict usage time per user account. Similar to those for restricting TV viewing time, these methods can be inaccurate in counting the actual PC screen viewing time. Therefore, they also suffer from the similar problems due to under- and over-counting discussed above.

In summary, there are significant limitations in prior arts in helping media viewers to keep proper viewing habits. For reading and writing on paper sheets, existing methods in help maintain proper posture are inconvenient. For viewing on modern media such as TV, PC and game console screens, existing methods in controlling viewing time needs to be more effective. In particular, they do not take into account important health-related viewing behaviors such as maintaining proper posture, eye-to-media distance and having regular breaks.

The present invention overcomes the limitations in the prior arts. It provides a convenient and effective solution to helping viewers maintain a wide range of healthy viewing behaviors.

### BRIEF DESCRIPTION OF THE DRAWINGS

FIG. 1 illustrates a media viewer behavior evaluation system, in accordance with one embodiment.

FIG. 2 is a flow chart describing a media viewer behavior tracking process, in accordance with one embodiment.

FIG. 3 is a flow chart describing a media viewer behavior analysis procedure, in accordance with one embodiment.

FIG. 4 is a flow chart describing a media viewer detection procedure, in accordance with one embodiment.

FIG. 5 is a flow chart describing a media viewer validation procedure, in accordance with one embodiment.

FIG. 6 is a flow chart describing a human visual focus analysis procedure, in accordance with one embodiment.

FIG. 7 a flow chart describing a procedure that analyzes viewing behavior other than visual focus, in accordance with one embodiment.

FIG. 8 is a flow chart describing a viewer identification procedure, in accordance with one embodiment.

FIG. 9 is a flow chart describing a viewer identification procedure with age estimation, in accordance with one embodiment.

FIG. 10 is a flow chart describing a media state and viewer behavior tracking process, in accordance with one embodiment.

FIG. 11 is a media viewer health care system in according with the invention, in accordance with one embodiment.

FIG. 12A illustrates some exemplary rules of proper viewing behavior, in accordance with one embodiment.

FIG. 12B illustrates more exemplary rules of proper viewing behavior, in accordance with one embodiment.

FIG. 13 illustrates some exemplary penalizing viewing policies, in accordance with one embodiment.

FIG. 14 illustrates more exemplary rewarding viewing policies, in accordance with one embodiment.

FIG. 15 is a flow chart describing a viewing policy enforcing process, in accordance with one embodiment.

FIG. 16 is a flow chart describing a viewing policy enforcing procedure, in accordance with one embodiment.

FIG. 17 is a flow chart describing a procedure that executes a viewing policy, in accordance with one embodiment.

FIG. 18 illustrates a media viewer health care system monitoring viewing space of multiple media, in accordance with one embodiment.

### DESCRIPTION OF THE SPECIFIC EMBODIMENTS

The description comprises two parts. In the first part, it focuses on exemplary embodiments that automatically evaluate viewing behavior of media viewers. In the second part, it focuses on exemplary embodiments that automatically deliver a health care feature to media viewers. The exemplary embodiments in the second part applies the principle of automatic viewing behavior evaluation illustrated in the first part.

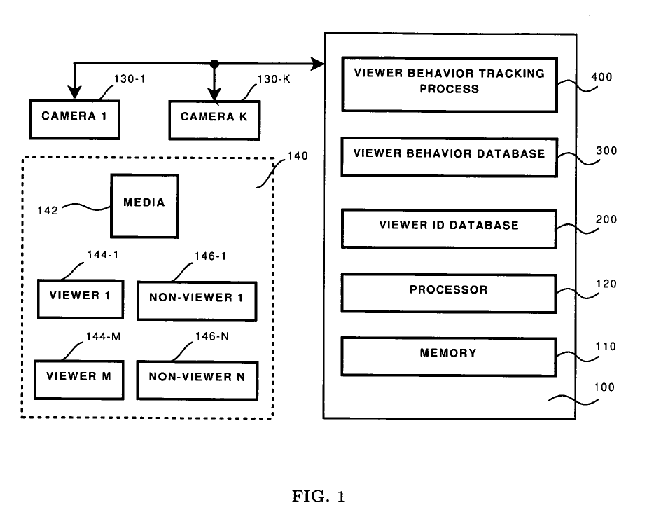

As one embodiment, FIG. 1 illustrates an exemplary system 100 that automatically evaluates viewing behavior of viewers of a media 142. Hereinafter, the said system is referred to as the media viewer behavior evaluation system 100, the system 100, or simply the system whenever it is clear from the context. The system includes one or more cameras 130-1 through 130-K that capture images of the viewing space 140 of the media 142. Hereinafter these cameras are also collectively referred to as image capturing devices 130. From the captured images, the system evaluates the viewing behavior of the media viewers.

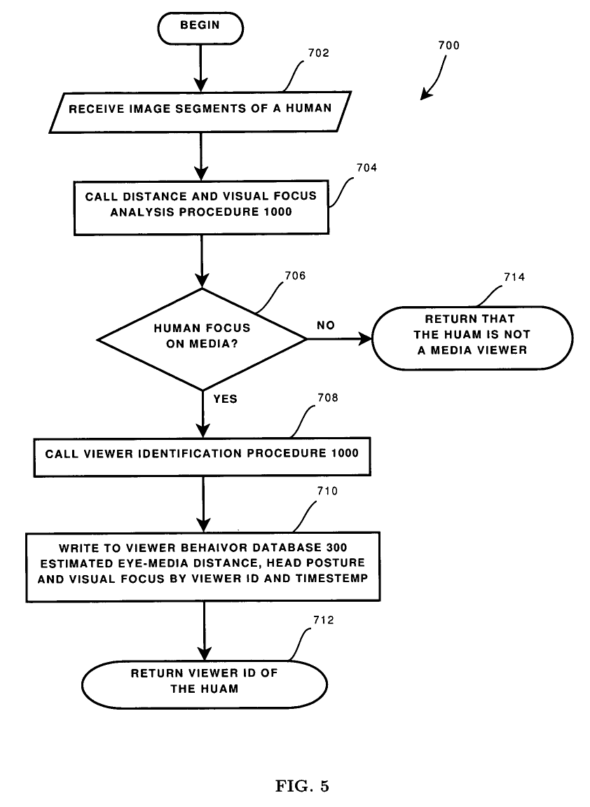

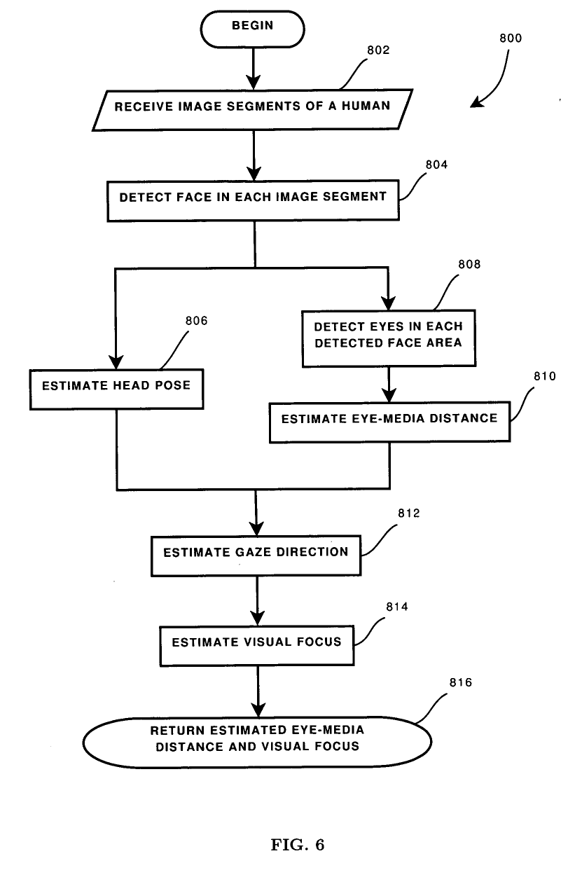

The exemplary media viewer behavior evaluation system 100 includes a viewer behavior tracking process 400. As one function of process 400, the system 100 uses machine vision (MV) to detect humans who are viewing the media 142 referred to as viewers 144-1 through 144-M in the viewing space 140 wherein others that are not viewing the media referred to as 146-1 through 146-N may be present simultaneously. The number of viewers M and the number of non-viewers N may vary as time goes by. In particular, there may not be any viewer or may not be any non-viewer at any time. The said detection of viewers and non-viewers using MV techniques will be described in conjunction with FIG. 5 and FIG. 6.

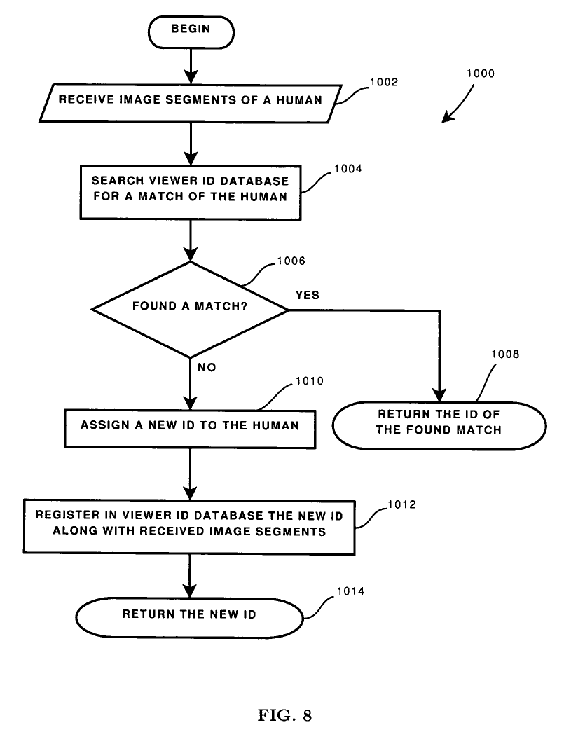

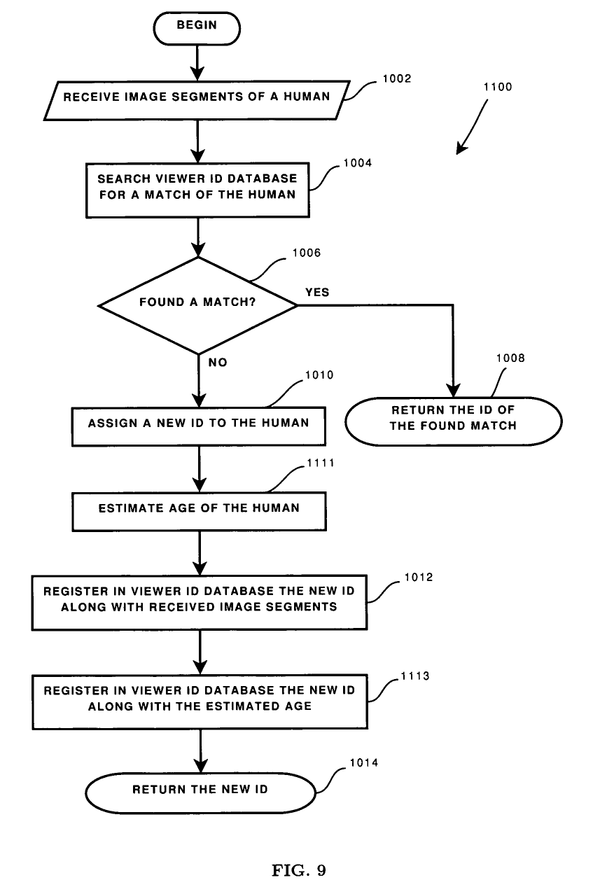

As another function of process 400, the system 100 identifies each detected viewer and stores the result in a viewer identification database 200 referred to hereinafter as a viewer ID database. The operation of a viewer ID database may depend on the types of the media and the viewers as will be described in conjunction with exemplary embodiments in FIG. 8 and FIG. 9.

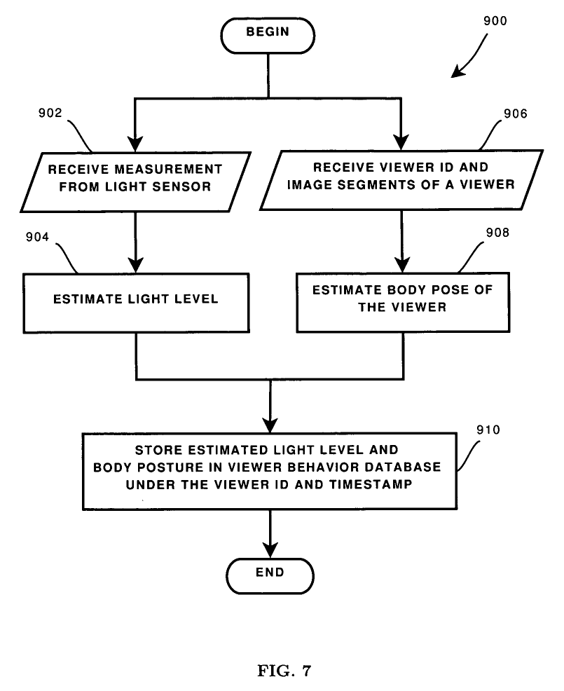

As yet another function of process 400, the system 100 evaluates the viewing behaviors of detected viewers and stores the evaluation result in viewer behavior database 300. The evaluation of viewing behaviors of a viewer will be described in conjunction with FIG. 5, FIG. 6 and FIG. 7.

The media viewer health care system 100 may be embodied as any computing device, such as a personal computer and an embedded system, that comprises a processor 110, such as a general-purpose processor or a graphics processor, and memory 120, such as random access memory (RAM) and read-only memory (ROM). Alternatively, the system may be embodied using one or more application specific integrated circuits (ASIC).

More illustrative information will now be set forth regarding various optional architectures and features of different embodiments with which the foregoing framework may or may not be implemented, per the desire of the user. It should be strongly noted that the following information is set forth for illustrative purpose only and should not be construed as limiting in any manner. Any of the following features may be optionally incorporated with or without the other features described.

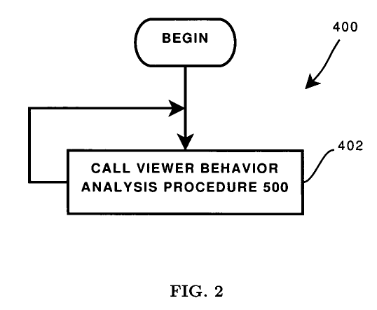

FIG. 2 is a flow chart describing the exemplary viewer behavior tracking process 400. The goal of this process is to detect any viewers in the viewing space of the media 140 and to determine their viewing behaviors. The process is cyclic. During each cycle in step 402, it calls the viewer behavior analysis procedure 500.

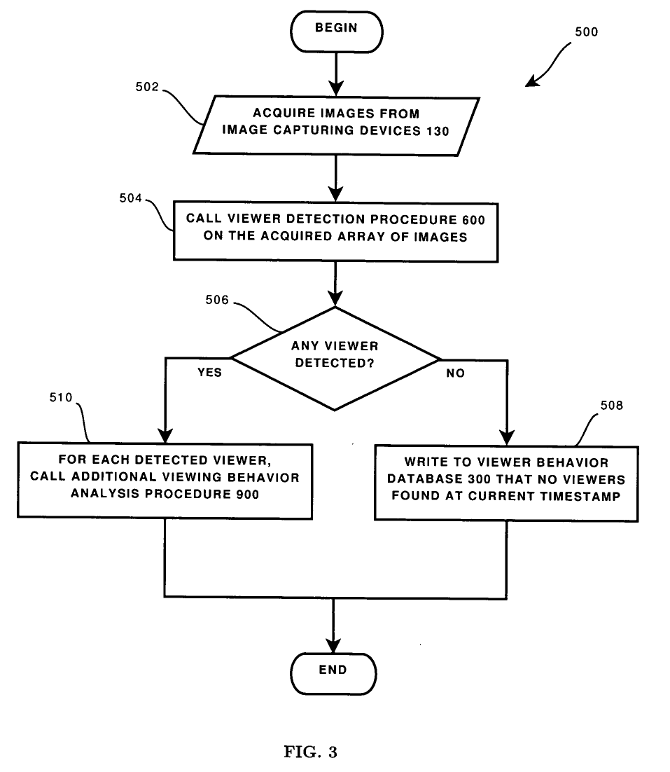

FIG. 3 is a flow chart describing an exemplary viewer behavior analysis procedure 500 which may be repeatedly invoked by the viewer behavior tracking process 400 as discussed above. The procedure first obtains images from the image capturing devices 130 during step 502. It then detects any viewers in the acquired images during step 504 by calling an exemplary viewer detection procedure 600 which is described in FIG. 8 wherein some viewing behaviors such as visual focus and eye-to-media distance are also determined. The procedure then performs a test in step 506 to check if any viewer is detected. If no viewer is detected, the procedure writes to the viewer behavior database 300 in step 508 that there is no viewer found at this time and then returns to the caller. If at least one viewer is detected, the procedure analyzes in step 510 additional viewing behaviors of each viewer detected before it returns to the caller. An exemplary procedure 900 for additional viewing behavior analysis is described in FIG. 7.

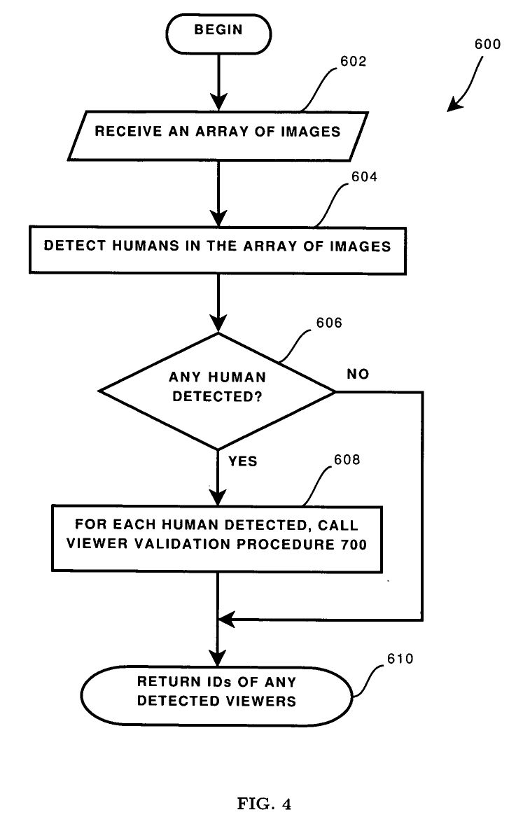

FIG. 4 is a flow chart describing an exemplary viewer detection procedure 600. The procedure comprises two main stages. The first stage consists of steps 602 and 604. In step 602, the procedure starts by receiving an array of images of the viewing space, for example, those acquired by image capturing device 130 in step 502. In step 604, the procedure detects humans in the images obtained during step 602. If there is no human detected as checked in step 606, the procedure returns in step 610, notifying the caller that there is no viewer detected. Otherwise, the procedure performs the second stage to determine whether each of the detected humans is a media viewer by calling viewer validation procedure 700 on the human in step 608 wherein the procedure 700 also associates the human with a unique identification (ID) if it determines the human is a media viewer, and then returns to the caller in step 610, notifying the caller of any detected viewers with their identifications. The viewer validation procedure 700 is described in conjunction with FIG. 5, FIG. 6, FIG. 8 and FIG. 9.

During step 604 in the first stage of the viewer detection procedure 600, the images are analyzed using machine vision (MV) techniques to detect humans. There is an extensive literature on object detection in images. For a detailed discussion on suitable MV techniques for human detection, see, for example, Mohan, Papageorgiou and Poggio, “Example-based object detection in images by components,” IEEE Trans. on Pattern Analysis and Machine Intelligence, Vol. 23, No. 4, pages 349-361 (April 2001), Viola and Jones, “Rapid object detection using a boosted cascade of simple features,” Proc. IEEE Conf. on Computer Vision and Pattern Recognition, Kauai, Hi. (December 2001), Ronfard, Schmid and Triggs, “Learning to parse pictures of people,” Proc. 7th European Conf. on Computer Vision, Copenhagen, Denmark, Part IV, pages 700-714 (June 2002), and Mikolajczyk, Schmid and Zisserman, “Human detection based on a probabilistic assembly of robust part detectors,” Proc. 8th European Conference on Computer Vision, Prague, Czech Republic, Volume I, pages 69-81 (May 2004), incorporated by reference herein.

FIG. 5 is a flow chart describing an exemplary media viewer validation procedure 700. The procedure may be called by the viewer detection procedure 600 in step 608 to determine if a human detected in the images is a media viewer as outlined before. As shown in the FIG. 5, the media viewer validation procedure 700 starts by receiving the image segments of the human in step 702. It then performs two major steps 704 and 708. In step 704, it estimates the visual focus of the human by calling another procedure 800 which is described in FIG. 6. Based on the estimated visual focus, a test is performed in step 706 to check if the human is focused on the media. If not, the procedure determines the human is not a media viewer and returns to the caller accordingly in step 714. If, however, the human is determined to be focused on the media, the procedure performs step 708 where a separate procedure 1000 is called to determine the viewer identification (ID) of the human to be described in conjunction with FIG. 8. Afterward, the relevant viewing behavior data estimated during step 704 including the distance between the eyes and the media, the head pose and visual focus of the human are stored into the viewer behavior database 300 under the viewer ID of the human as determined during step 708 and the current time stamp. The procedure 700 finally returns to the caller with the viewer ID of the human in step 712.

FIG. 6 is a flow chart describing an exemplary procedure 800 that analyzes the visual focus of a human detected in the images based on machine vision (MV) techniques. The procedure may be called by procedure 700 to determine whether the human is viewing the media. After receiving image segments of a human in step 802, the procedure first locates the face of the human in the image segments in step 804, and then estimates the pose of the head in step 806, detects the eyes in step 808 and then estimates the distance between the eyes and the media in step 810. Based on the estimated head pose and eye-media distance, the gaze direction of the human is estimated in step 812. Based on the estimated gaze direction and eye-media distance, the area of visual focus of the human is estimated in step 814. Finally, the estimation results including eye-media distance, head pose and area of visual focus are returned to the caller in step 816. Again, it should be noted that the procedure described in FIG. 6 is for illustrative purpose only, and should not be construed as limiting in any manner. For instance, in a circumstance such as in TV watching where eye-to-media distance may be adequately estimated by head-to-media distance, it is then unnecessary to detect eyes and estimate their distance from the media.

The face detection operation is performed in step 804 wherein the image segments of a detected human received in step 802 are analyzed using MV techniques. There is an extensive literature on face detection in images. For a detailed discussion on suitable face detection techniques, see, for example, Yang, Kriegman and Ahuja, “Detecting faces in images: A survey,” IEEE Trans. on Pattern Analysis and Machine Intelligence, Vol. 24, No. 1, pages 34-58 (January 2002), Sung and Poggio, “Example-based learning for view-based human face detection,” IEEE Trans. on Pattern Analysis and Machine Intelligence, Vol. 20, No. 1, pages 39-51 (January 1998), Keren, Osadchy and Gotsman, “Antifaces: A novel fast method for image detection,” IEEE Trans. on Pattern Analysis and Machine Intelligence, Vol. 23, No. 7, pages 747-761 (July 2001), Viola and Jones, “Robust real-time face detection,” Int'l J. of Computer Vision, Vol. 57, No. 2, pages 137-154 (May 2004), Osadchy, LeCun and Miller, “Synergistic face detection and pose estimation with energy-based models,” J. of Machine Learning Research, Vol. 8, pages 1197-1214 (May 2007), and Hiesele, Serre and Poggio, “A component-based framework for face detection and identification,” Int'l J. of Computer Vision, Vol. 74, No. 2, pages 167-181 (August 2007), incorporated by reference herein.

As outlined before, after detecting the face of the human in each image segment in step 804, the procedure 800 next analyzes the image regions of the detected faces in the image segments. These analyses include head pose estimation in step 806, eye detection in step 808 and eye-media distance estimation in step 810. Based on the results from these analyses, step 812 estimates the gaze direction of the detected human.

There is an extensive literature on head pose estimation using MV techniques to determine the pan, tilt and roll angles of a human head. For a detailed discussion on suitable head pose estimation techniques for step 806, see, for example, Murphy-Chutorian and Trivedi, “Head Pose Estimation in Computer Vision: A Survey,” IEEE Trans. on Pattern Analysis and Machine Intelligence, PrePrints (April 2008), Kruger, Potzsch and von der Malsburg, “Determination of face position and pose with a learned representation based on labeled graphs,” Image and Vision Computing, Vol. 15, No. 8, Pages 665-673 (August 1997), Huang, Shao and Wechsler, “Face pose discrimination using support vector machines (SVM),” Proc. Int'l. Conf. Pattern Recognition, pages 154-156 (August 1998), Matsumoto and Zelinsky, “An algorithm for real-time stereo vision implementation of head pose and gaze direction measurement,” Proc. IEEE 4th Int. Conf. on Automatic Face and Gesture Recognition, pages 499-504 (March 2000), Sherrah, Gong and Ong, “Face distributions in similarity space under varying head pose,” Image and Vision Computing, Vol. 19, No. 12, pages 807-819 (December 2001), and Moon and Miller, “Estimating facial pose from a sparse representation,” Proc. Int'l Conf. on Image Processing, pages. 75-78 (October 2004), incorporated by reference herein.

Step 808 detects eyes in image regions of the face detected in step 804 again using machine vision techniques. There is also an extensive literature on eye detection in face images. For a discussion on suitable eye detection techniques, see, for example, Lam and Yan, “Locating and extracting the eye in human face images,” Pattern Recognition, Vol. 29, No. 5, pages 771-779 (May 1996), Huang and Wechsler, “Eye detection using optimal wavelet packets and radial basis functions,” J. of Pattern Recognition and Artificial Intelligence, Vol. 13, No. 7, pages 1009-1025 (July 1999), Sirohey and Rosenfeld, “Eye detection in a face image using linear and nonlinear filters,” Pattern Recognition, Vol. 34, No. 7, pages 1367-1391 (July 2001), and Peng, Chen and Ruan, “A Robust and Efficient Algorithm for Eye Detection on Gray Intensity Face,” J. of Computer Science and Technology, Vol. 5, No. 3, pages 127-132 (October 2005), incorporated by reference herein.

Step 810 estimates the distance between the eyes of the human and the media based on the image regions of the eyes detected in Step 808. According to one embodiment of the invention, the said distance is estimated using the well-known triangulation process in trigonometry and geometry that can be used to determine the location of an item in three-dimensional (3D) space. For a discussion on applying triangulation process in a 3D position measuring system, see, for example, Teutsch, “Model-based analysis and evaluation of point sets from optical 3D laser scanners,” Ph.D. Thesis, Shaker Verlag, ISBN: 978-3-8322-6775-9 (2007). The location of a detected eye in each of the images, the focal lengths of the cameras and the distance between the image capture devices 130 are sufficient to carry out the triangulation process which determines the location of each of the eyes relative to the locations of the image capture devices 130 in 3D space. According to one embodiment of the invention wherein the 3D positions of the image capturing devices 130 relative to the media are fixed and predetermined, for example, if the media is a PC monitor screen or a TV screen and the image capture devices 130 are conveniently placed next to such a screen media, the distance between the eyes and the media can be determined by simply combining the positions of the eyes relative to the image capturing devices 130 as determined by triangulation described above and the positions of the image capturing devices 130 relative to the media.

According to one embodiment of the invention wherein the positions of the image capturing devices 130 relative to the media are not fixed or not predetermined, for example, if the media is a book, a notepad or in any other scenarios where the image capturing devices 130 may not be conveniently placed in fixed positions relative to the media, the estimation of the distance between the eyes of the detected viewer and the media in step 810 further determines the position of the media relative to the image capturing devices 130. The position of the media relative to the image capturing devices 130 may be determined in a mechanism similar to that of eyes relative to the image capturing devices 130 described above wherein the media is detected using MV techniques and localized in the space relative to the cameras using triangulation. There is an extensive literature on generic object detection using machine vision. For a discussion on suitable techniques, see, for example, Papageorgiou and Poggio, “A trainable system for object detection,” Int'l. J. of Computer Vision, Vol. 38, No. 1, pages 15-33 (June 2000), Viola, Jones and Snow, “Robust real-time object detection,” Int'l J. of Computer Vision, Vol. 57, No. 2, pages 137-154 (May 2004), Bochard and Triggs, “A hierarchical part-based model for visual object categorization,” Proc. IEEE Int'l Conf. on Computer Vision and Pattern Recognition, pages 710-715 (June 2005), Fergus, Perona and Zisserman, “A sparse object category model for efficient learning and exhaustive recognition,” Proc. IEEE Int'l Conf. on Computer Vision and Pattern Recognition, pages 710-715 (June 2005), incorporated by reference herein.

Step 812 estimates the gaze direction of the human in image segments received in Step 802. In normal situations wherein the human is assumed to be looking straight ahead, the gaze direction of the human can be directly computed as the angle perpendicular to the face of the human as determined by the pan and tilt angles of the head pose estimated in Step 806. If more accuracy of gaze direction estimation is desired, the iris and pupil centers of the eyes may be detected using MV techniques and the gaze direction estimate may be adjusted by adding the iris direction and the head pan and tilt angles together, see, for example, Daugman, “High confidence visual recognition of persons by a test of statistical independence,” IEEE Trans. on Pattern Recognition and Machine Intelligence, Vol. 15, No. 11, pages 1148-1161 (November 1993) where iris and pupil centers are modeled and detected explicitly, and Tan, Kriegman and Ahuja, “Appearance-based eye gaze estimation,” Proc. 6th IEEE Workshop on Applications of Computer Vision, pages 191-195 (December 2002) where iris and pupil centers are detected indirectly based on an appearance-manifold model.

Based on the position of the human eyes relative to the media from step 810 and gaze direction from step 812, step 814 estimates the visual focus of the human on in the plane spanned by the media. In particular, it determines whether the visual focus overlaps the media in which case the human is considered to be focused on the media and hence is considered as viewing the media at the moment.

Finally in step 816, relevant estimation results such as eye-media distance and visual focus of the human in the image segments received in step 802 are returned to the caller.

FIG. 7 is a flow chart illustrating an exemplary embodiment of procedure 900 to analyze relevant viewing behavior of a media viewer. In the context of the viewer behavior analysis procedure 500, this procedure is invoked in step 510 to analyze additional viewing behavior of a detected media viewer other than the visual focus as estimated in media viewer detection procedure 800. It estimates the ambient illumination level around the viewing space in steps 902 and 904 and the body pose of the media viewer in steps 906 and 908. Again, the example is for illustrative purpose only and should not be construed as limiting in any manner.

According to one embodiment of the invention, a dedicated light level sensor, for example, the low-voltage ambient light sensor model APDS-9300 of Avago Technologies, Inc., San Jose, Calif., is employed. The measurement signals from the light sensor is received in step 902 based on which the light level is estimated simply as the measurement from the sensor in step 904.

According to another embodiment of the invention, the image capturing devices 130 are used for light level estimation to save the cost of a dedicated light level sensor. In this case, the light sensor in step 902 refers to the image capturing devices 130 and the measurement is the images of the media viewing space captured by the image capturing devices 130. In step 904, the images are analyzed to estimate the light level of the viewing space, for instance, by averaging the pixel luminance levels of the images captured by the image capturing devices 130.

In step 906, the procedure receives the viewer ID and image segments of the viewer to be analyzed. In step 908, the received image segments are analyzed for the body pose of the viewer using MV techniques. Exemplary body poses that are generally important to avoid and hence to be detected include lying down, a titled shoulder and a hunched back during media viewing time. There is an extensive literature on MV techniques for body pose estimation from images. For a discussion on suitable MV techniques for body pose estimation, see, for example, Taylor, “Reconstruction of articulated objects from point correspondences in a single uncalibrated image,” Computer Vision and Image Understanding, Vol. 80, No. 3, pages 349-363 (December 2000), Mori and Malik, “Estimating human body configurations using shape context matching,” Proc. 7th European Conf. on Computer Vision, Part III, pages 660-668, Copenhagen, Denmark (June 2002), Sigal and Black, “Measure locally, reason globally: Occlusion-sensitive articulated pose estimation,” Proc. IEEE Conf. on Computer Vision and Pattern Recognition, pages 2041-2048 (June 2006), incorporated by reference herein.

In step 910, the procedure 900 stores the estimated light level and body pose of the viewer into the viewer behavior database 300 using the viewer ID received in step 906 and the current timestamp as the key, and then returns to the caller.

FIG. 8 is a flow chart illustrating an embodiment of viewer identification procedure 1000 that identifies a human using MV techniques. In the context of media viewer detection procedure 700, see FIG. 7, procedure 1000 is invoked wherein the human to be identified is already determined to be a media viewer and the result of procedure 1000 is a unique identification for the media viewer (viewer ID) based on which the viewing behavior of a viewer can be retrieved and accumulated across different viewing sessions.

As shown in FIG. 8, procedure 1000 begins by receiving the image segments of a human in step 1002 and searches for a match of the human with any of known humans in the viewer ID database 200 in step 1004. Based on the search result, the procedure decides in step 1006 whether to retrieve an existing viewer ID or assign a new viewer ID for the human. If a match is found, i.e., there is a previously identified viewer matches the human in the received image segments, the procedure retrieves and returns the viewer ID of the previously identified viewer in step 1008. Otherwise, a new viewer ID is assigned to the human in step 1010, then the newly assigned viewer ID and the image segments of the human received in step 1002 are stored together in the viewer ID database 200 in step 1012 for future viewer ID search, and finally the newly assigned viewer ID is returned in step 1014.

Step 1004 uses MV techniques to analyze the image segments of a human to determine if the human matches the image segments of a known human in the viewer ID database 200, a problem well-known as human recognition and extensively studied as human face recognition in the literature. For a comprehensive discussion on suitable MV techniques for face recognition, see, for example, Zhao, Chellappa, Phillips and Rosenfeld “Face recognition: A literature survey,” ACM Computing Surveys, Vol. 35, No. 4, pages 399-458 (December 2003), incorporated by reference herein.

In the above embodiment of viewer identification procedure 1000, a new media viewer is automatically registered in the media viewer behavior evaluation system 100 in step 1010 wherein the viewer is assigned a unique ID and in step 1012 wherein the image segments of the viewer is stored into the viewer ID database 200 along with the assigned viewer ID. Alternatively, a new media viewer may be registered in the system manually, for example, by assigning a unique ID to the viewer, obtaining frontal and representative profile images of the media viewer via the image capturing devices 130, and then storing the obtained images of the viewer into the viewer ID database 200 along with the viewer ID.

As described above, the viewer identification procedure 1000 in FIG. 8 identifies media viewers explicitly using machine vision techniques. It may be employed in a circumstance where there is a need to track the viewing behavior of a same viewer across different viewing sessions of a same or different multiple media. Depending on the specific application of the system, media viewer identification may be embodied differently, with or without machine techniques. In another embodiment, there may be at most one media viewer in the viewing space at a time and there is no need to track viewing behavior of a viewer across viewing sessions. Under such a circumstance, it suffices for the viewer identification procedure performed in step 708 to simply return an arbitrary yet fixed ID always. As a matter of fact, in such a case, the media identification procedure may be omitted altogether in the exemplary viewer behavior evaluation system 100. In yet another embodiment, there may be multiple media viewers but there is no need to track viewer behavior across viewing sessions. Under such a circumstance, it suffices for a viewer identification procedure to assign a unique ID to each of the detected viewers and track each viewer until the viewer ends the current viewing session. There is an extensive literature on tracking human bodies based machine vision, see for example the techniques taught in Wren, Azarbayejani, Darrell and Pentland, “Pfinder: real-time tracking of the human body,” IEEE Trans. on Pattern Analysis and Machine Intelligence, Vol. 19, No. 7, pages 780-785 (July 1997), and in Zhou and Hoang, “Real time robust human detection and tracking system,” Proc. IEEE Conf. on Computer Vision and Pattern Recognition, Vol. 3, pages 149-149 (June 2005), incorporated by reference herein. In still yet another embodiment where there are multiple media viewers whose individual physical locations are known a priori, for example, as a location and viewer ID map. Under such a circumstance, it suffices for a viewer identification procedure to determine the physical location of each of the detected viewer and then lookup the ID of the viewer from the said location and viewer ID map.

Generally, the operation of identifying media viewers can be considered as classifying media viewers according to specific viewer attributes. For example, in one embodiment, a viewer may be optionally identified as belonging to a specific age group. Such classification is useful, for example, to analyze whether the viewing behavior of a viewer is proper according to an age-dependent viewing behavior guidance or rule. Viewing behavior rules will be introduced and illustrated later in the embodiments of a media viewer health care method and system of the invention. The age of a viewer may be determined manually, for example, when the viewer is registered with the system. Either the viewer or a supervisor may supply the system with the age of the viewer which is then stored in the viewer ID database 200. Alternatively, the age of a viewer may be estimated automatically using MV techniques, for example, when the viewer is identified as a new viewer in the viewer identification process. This is illustrated as an embodiment of viewer identification procedure 1100 in FIG. 9 which may be invoked in step 708 of viewer validation procedure 700 in place of procedure 1000 described previously. As shown in FIG. 9, the procedure 1100 has a flow chart identical to that of procedure 1000 in FIG. 8 except that it has two additional steps, a step 1111 that estimates the age of the viewer from the image segments of the viewer received in step 1102 and a step 1113 that stores the estimated age of the viewer in the viewer ID database 200. There is an extensive literature on estimating human age using MV techniques. For example, the technique taught by Guo, Fu, Dyer and Huang in “Image-based human age estimation by manifold learning and locally adjusted robust regression,” IEEE Trans. on Image Processing, Vol. 17, No. 7, pages 1178-1188 (July 2008) incorporated by reference herein may be employed in estimating viewer age in step 1111. Again, it should be noted that the foregoing embodiments for media viewer classification are for illustrative purpose only and should not be construed as limiting in any manner.

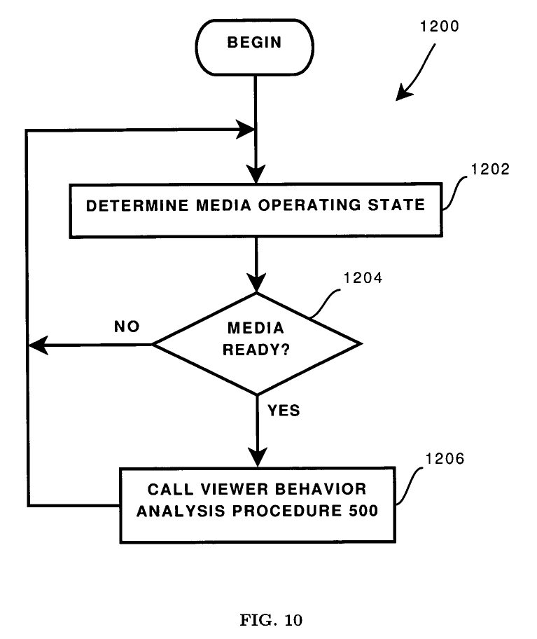

In the embodiment of viewer behavior tracking process 400 in FIG. 2, it is assumed when a human visually focuses on a media, the human is viewing the media. This assumption holds in a typical scenario, for example, when a human is visually focusing on a book, the human is generally reading or writing, when a human is visually focusing on a PC monitor screen, the human is generally viewing the content on the PC monitor screen, and when a human is visually focusing on a TV screen, the human is generally watching TV. If it is desired to exclude the case wherein a human is visually focusing on a media but the media is not ready for viewing, for example, the human is watching TV screen that is turned off, an explicit check of the media operating state may be performed when tracking the viewing behavior of media viewers as illustrated in FIG. 10, resulting in another embodiment of viewer behavior tracking procedure 1200. As shown in FIG. 2 and FIG. 10, both the viewer behavior tracking processes 400 and 1200 are cyclic and both incorporate the viewer behavior analysis procedure 500. Their difference lies in that process 400 calls viewer behavior analysis procedure 500 each cycle whereas procedure 1200 calls viewer behavior analysis procedure 500 in a cycle only if the media is ready for viewing in that cycle as determined in the step 1202 and tested in step 1204.

A variety of techniques may be employed to determine the operating state of a media device in step 1202. Below are several examples of such techniques. Again, these are for illustrative purpose only and should not be construed as limiting in any manner. If a media viewer behavior evaluation system 100 is natively integrated with the media device such as a TV set, a PC or a game console, it is straightforward to determine the media device operating state. Otherwise if the media device is programmable for general purpose such as a PC with a standard communication interface, it is straightforward to write a program to run on the media device which informs the media viewer behavior evaluation system 100 via the said communication interface. Still yet if no direct access to the media device operating state is possible, indirect techniques may be employed to determine the media operating state. For example, U.S. Pat. No. 7,343,615 entitled “Television proximity sensor” issued to Nelson et al (March 2008) teaches an indirect technique to determine whether a display is turned on by detecting a characteristic audio signal emitted from the transformer of the display. As another example of indirect techniques to determine if a media is turned on, the images acquired by the image capturing devices 130 may be analyzed using machine vision techniques wherein the display of the media device may be optionally located in the images using object detection techniques referenced in the discussion of step 604. Then, the image regions corresponding to the display may be analyzed, for example, by comparing them to their corresponding image values in the background when the media device is turned off.

To illustrate the basic principle of media viewer behavior evaluation of the invention, the machine vision (MV) techniques employed in the embodiments described thus far have been mostly restricted to analyzing contents of still images. More specifically, the images captured by the image capturing devices 130 at one time instance are analyzed separately from those captured at another time instance although images captured by individual image capturing devices 130 at each time instance are analyzed together to explore their spatial correlation.

The invention may also be embodied based on various video-based MV techniques wherein the images captured by the image capturing devices 130 are analyzed as video sequences. By exploring the spatial and temporal correlation of objects in consecutive images of the video sequences, video-based MV techniques are typically capable of tracking objects in the video sequences and consequently may achieve better quality-of-results (QoR) and simplify the analysis to reduce the amount of needed computation. There is an extensive literature on video-based MV techniques suitable to implement all tasks in the previous embodiments that require visual content analysis as discussed below by examples.

Human detection in step 604 of media viewer detection procedure 600 may be performed in video using techniques taught in, see, for example, Wren, Azarbayejani, Darrell and Pentland. “Pfinder: real-time tracking of the human body,” IEEE Trans. on Pattern Analysis and Machine Intelligence, Vol. 19, No. 7, pages 780-785 (July 1997), and Zhou and Hoang, “Real time robust human detection and tracking system,” Proc. IEEE Conf. on Computer Vision and Pattern Recognition, Vol. 3, pages 149-149 (June 2005), incorporated by reference herein.

Face detection in step 804 of the exemplary distance and visual focus analysis procedure 800 in video may employ techniques taught in, see, for example, Mkolajczyk, Choudhury and Schmid, “Face detection in a video sequence—a temporal approach,” Proc. IEEE Conf. on Computer Vision and Pattern Recognition, Vol. II., pages 96-101 (December 2001), Froba and Kublbeck, “Face Tracking by Means of Continuous Detection,” Proc. CVPR Workshop on Face Processing in Video, pages 65-66 (June 2004), and Gorodnichy, “Seeing faces in video by computers. Editorial for Special Issue on Face Processing in Video Sequences,” Image and Vision Computing, Vol. 24, No. 6, pages 551-556 (June 2006), incorporated by reference herein.

Head pose estimation in step 806 of the exemplary distance and visual focus analysis procedure 800 in video may employ techniques taught in, see, for example, Morency, A. Rahimi, N. Checka, and T. Darrell, “Fast stereo-based head tracking for interactive environments,” Proc. Int'l. Conf. Automatic Face and Gesture Recognition, pages 375-380 (May 2002), Huang and Trivedi, “Robust Real-Time Detection, Tracking, and Pose Estimation of Faces in Video Streams,” Proc. IEEE Int'l Conf. Pattern Recognition, pages 965-968 (August 2004), and Oka, Sato, Nakanishi and Koike, “Head pose estimation system based on particle filtering with adaptive diffusion control,” Proc. Int'l Conf. on Machine Vision Applications, pages 586-589 (May 2005), incorporated by reference herein.

Eye detection in step 808 of the exemplary distance and visual focus analysis procedure 800 in video may employ techniques taught in, see for example, Stiefelhagen, Yang and Waibel, “Tracking eyes and monitoring eye gaze,” Proc. Workshop on Perceptual User Interfaces, pages 98-100 (October 1997), and Bakic and Stockman, “Real-time tracking of face feature and gaze direction determination,” Proc. 4th IEEE Workshop on Applications of Computer Vision, pages 256-257 (October 1998), incorporated by reference herein.

Body pose estimation in step 908 of additional viewing behavior analysis procedure 900 in video may employ techniques taught in, for example, Lee, Model-based human pose estimation and tracking, Ph.D. Thesis, Univ. Southern California, Los Angeles, Calif. (2006).

Human matching in step 1004 of the exemplary media viewer identification procedure 1000 may be performed using face recognition techniques in video taught in, for example, U.S. Pat. No. 6,301,370, entitled “Face recognition from video images,” issued to Steffens, Elagin, Nocera, Maurer and Neven (October 2001), and Gorodnichy, “Video-based framework for face recognition,” Proc. 2nd Workshop on Face Processing in Video within 2nd Canadian Conf. on Computer and Robot Vision, pages 330-338 (May 2005), incorporated by reference herein.

Optionally, depth information of image pixels may be used in performing various visual processing tasks of the invention. Known as range information, depth information of an image pixel is a measure of distance between the camera that captures the image and the object that corresponds to the pixel in the image. For example, depth information may be used in step 810 of viewer validation procedure 800 to estimate the distance between the eyes of the viewer and the media once the eyes are detected and located in the images in step 808. Depth information may be used to detect and recognize objects by separating objects from their backgrounds and determining object shapes, which may be employed in the present invention, for example, in detecting human in step 604 in the exemplary viewer detection procedure 600 in FIG. 4. For a discussion on detecting objects using depth information, see for example, Reeves and Taylor, “Identification of three-dimensional objects using range information,” IEEE Trans. on Pattern Analysis and Machine Intelligence, pages 403-410, Vol. 11, No. 4 (April 1989), incorporated by reference herein. There is an extensive literature on a variety of techniques to compute depth information from single and multiple images. For a discussion on suitable techniques to extract depth information from images, see, for example, Adelson and Wang, “Single lens stereo with plensoptic camera,” IEEE Trans. on Pattern Analysis and Machine Intelligence, Vol. 12, No. 2, pages 99-106 (February 1992), Saxena, Schulte and Ng, “Depth estimation using monocular and stereo cues,” Proc. Int'l Joint Conf. on Artificial Intelligence, pages 2197-2203 (January 2007), incorporated by reference herein. Depth information may be obtained directly using modern range cameras, see for example, Lange and Seitz, “Solid state time-of-flight range camera,” IEEE J. of Quantum Electronics, Val. 37, No. 3, pages 390-397 (March 2001), and Oggier et al., “An all-solid-state optical range camera for 3D real-time imaging with sub-centimeter depth resolution (SwissRanger),” Proc. SPIE, Vol. 5249, pages 534-545 (February 2004), incorporated by reference herein.

Other than visible wavelength and time-of-flight imageries described earlier, other types of imaging technologies may be employed to obtain images of the viewing space of a media of the invention. For example, one or more of the image capturing devices 130 may employ infrared imagery. As still another example, one or more of the image capturing devices 130 may employ hyperspectral imagery which collects information across a wider electromagnetic spectrum, from ultraviolet to infrared. For discussions on machine vision techniques using infrared imagery suitable to analyze viewing behavior of a media viewer as illustrated in the proceeding paragraphs, see for example, Eveland, Socolinsky and Wolff, “Tracking human faces in infrared video,” Image and Vision Computing, Vol. 21, No. 7, pages 579-590 (July 2003), Dowdall, Pavlidis and Bebis, “Face detection in the near-IR spectrum,” Image and Vision Computing, Vol. 21, No. 7, pages 565-578 (July 2003), Socolinsky, Selinger and Neuheisel, “Face recognition with visible and thermal infrared imagery,” Computer Vision and Image Understanding, Vol. 91, No. 1-2, pages 72-114 (July-August 2003) and Kong and et al, “Recent advances in visual and infrared face recognition: A review,” Computer Vision and Image Understanding, Vol. 97, No. 1, pages 103-135 (January 2005) for media viewer detection and identification, and Trivedi, Cheng, Childers and Krotosky, “Occupant posture analysis with stereo and thermal infrared video: algorithms and experimental evaluation,” IEEE Trans. on Vehicular Technology, Special Issue on In-Vehicle Vision Systems, Vol. 53, No. 6, pages 1698-1712 (November 2004) for viewer body pose estimation, incorporated by reference herein.

For a discussion on suitable techniques using hyperspectral imagery, see for example, Chou and Bajcsy, “Toward face detection, pose estimation and human recognition from hyperspectral imagery,” Technical Report NCSA-ALG04-0005, Automated Learning Group, National Center of Supercomputing Applications, Univ. of Illinois at Urbana Champion (October 2004), incorporated by reference herein.

The principle of media viewer behavior evaluation described above may be applied to provide media viewers with useful health care features according to the evaluation results of their viewing behaviors. This is illustrated by the below embodiments of a system that evaluates if any of the viewers of a media follows a set of rules of predefined viewing behaviors which are believed necessary for healthy viewing of the media. Generally, when the system determines a viewer violates or obeys by a rule, it performs appropriate actions to assist the said viewer in establishing and maintaining healthy viewing habits.

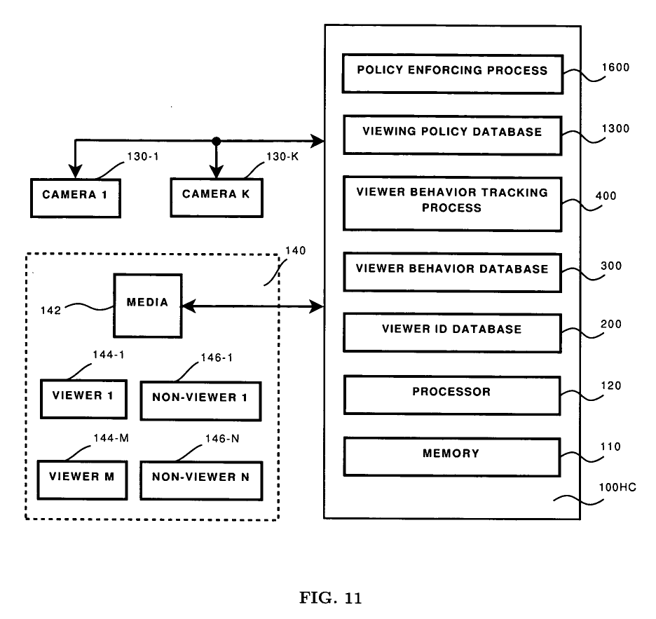

As one embodiment, FIG. 11 illustrates a media viewer health care system 100HC. This system extends the media viewer behavior evaluation system 100 in FIG. 1 to automatically provides a health-care feature for viewers of a media 142. Hereinafter this system is also referred to as the health care system 100HC or simply the system 100HC whereas the media viewer behavior evaluation system 100 is also referred to as the behavior evaluation system 100 or simply the system 100.

As the behavior evaluation system 100 in FIG. 1, the health care system 100HC in FIG. 11 comprises of image capturing devices 130 focused on the viewing space of the media 140, a viewer ID database 200, a viewer behavior database 300, a viewing behavior tracking procedure 500 that detects and evaluates the viewing behaviors of a possible varying number of viewers 144-1 through 144-M among a possibly varying number of non-viewers 146-1 through 146-N. The health care system 100HC further comprises a viewing policy database 1300 and a viewing policy enforcing process 1600.

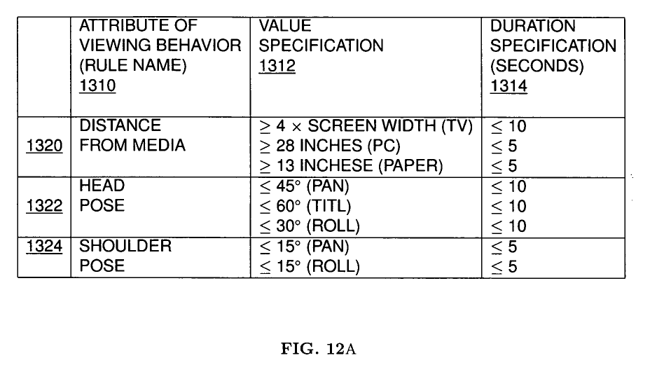

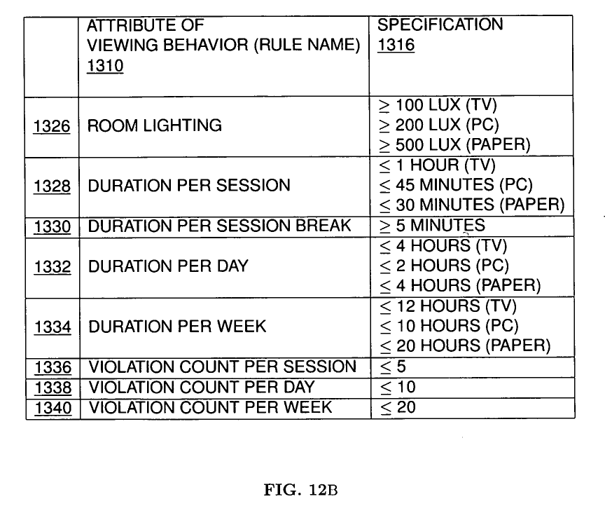

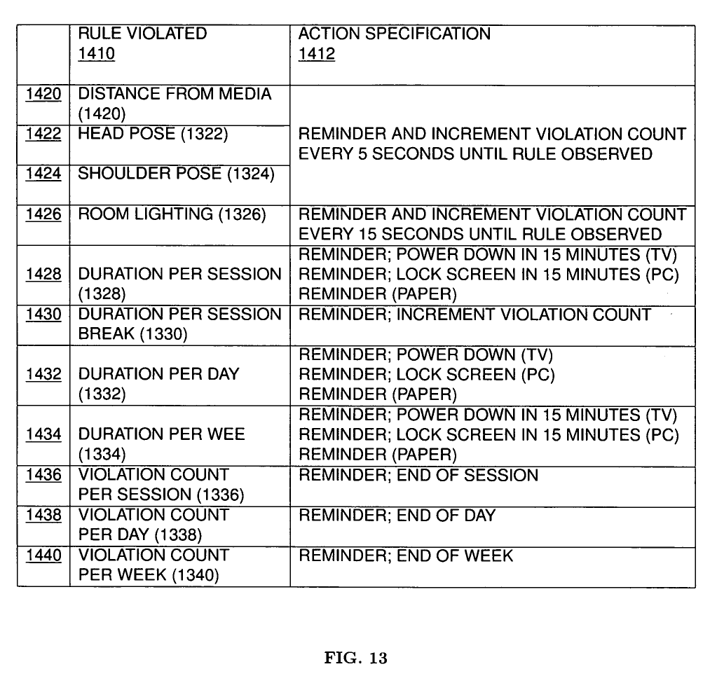

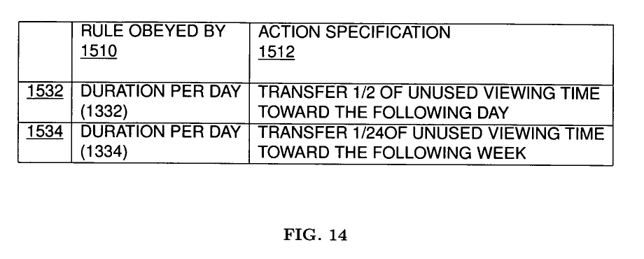

Generally, the viewing policy database 1300 comprises of viewing behavior rules and specification of actions if any of the rules are violated or observed which may be predefined or configured by a supervisor. FIG. 12A and FIG. 12B illustrate some examples of viewing behavior rules. When the system determines a viewer does not follow a rule, it executes one or more viewing policies concerning the violation of the rule by performing the actions associated with the said policies. Such policies hereinafter are referred to as penalizing policies and some exemplary penalizing policies are illustrated in FIG. 13. Conversely, when the system determines a viewer follows a rule, it executes one or more viewing policies, if any, concerning the observation of the rule. Such policies hereinafter are referred to as rewarding policies and some exemplary rewarding policies are illustrated in FIG. 14.

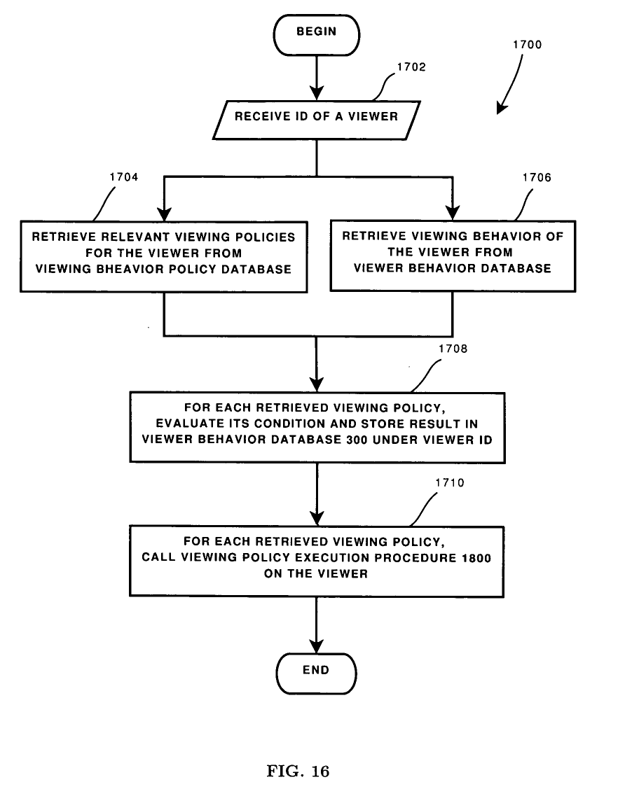

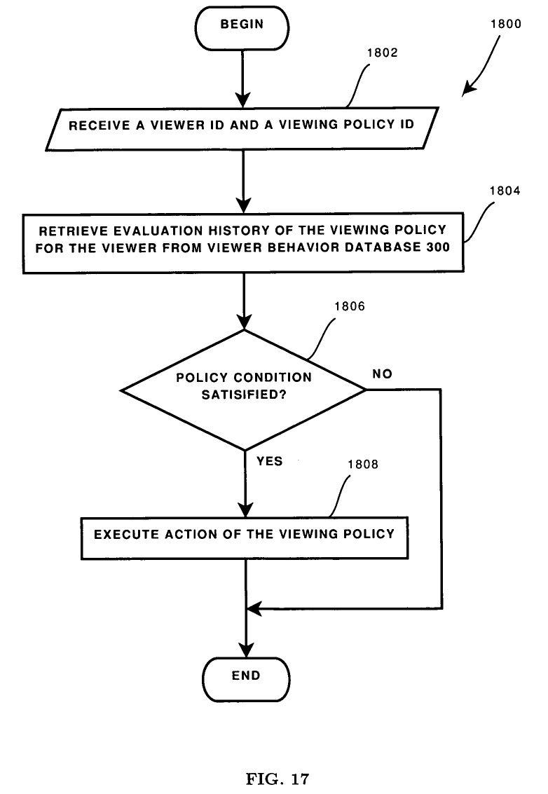

As a function of viewing policy enforcing process 1600, the media viewer health care system 100HC identifies all policies in viewing policy database 1300 that are applicable to a given viewer based on the viewing behavior of the said viewer stored in the viewer behavior database 300. The said applicable policy identification is described in conjunction with FIG. 16 and FIG. 17.

More illustrative information of the exemplary health care system 100HC will now be set forth regarding various optional architectures and features of different embodiments with which the foregoing framework may or may not be implemented, per the desire of the user. Again, it should be noted that the following information is set forth for illustrative purpose only and should not be construed as limiting in any any manner. Any of the following features may be optionally incorporated with or without the other features described.

The viewing policy database 1300 may be embodied by defining healthy viewing behaviors and the actions to be taken when a viewing behavior is detected as healthy and otherwise. Alternatively, the viewing policy database 1300 may be embodied by defining unhealthy viewing behaviors and the actions to be taken when a viewing behavior is detected as unhealthy and otherwise. Since a viewing behavior is considered either healthy or unhealthy generally, the above two embodiment styles are interchangeable. Hereinafter we choose to use the first style to further illustrate the viewing policy database 1300.

According to one embodiment of the invention, a healthy viewing behavior may be specified as a plurality of viewing behavior rules wherein each of the rules defines one aspect of a healthy viewing behavior. In one implementation of the invention, the said rules are conjunctive so that a healthy viewing behavior must observe all the rules. In an alternative implementation, the said rules are disjunctive so that a healthy viewing behavior need to observe only one of the rules. Due to DeMorgan Law, the two implementation styles are interchangeable. Hereinafter we choose to use the first style to illustrate the definition of a healthy viewing behavior.

As shown in FIG. 12A and FIG. 12B, the viewing behavior rules viewing policy database 1300 may be recorded as a plurality of tables. Each row of a table defines a viewing behavior rule regarding a specific aspect or attribute of a viewing behavior. More particularly, each row consists of a field identifying the specific attribute of a viewing behavior the rule is about and one or more fields that specify the conditions on the attribute value ranges within which the viewing behavior is considered healthy or acceptable.

FIG. 12A illustrates three exemplary viewing behavior rules 1320, 1322 and 1324, each with two specification fields, one defining the acceptable attribute values 1312 and the other defining the maximum duration 1314 for which a viewer may violate the specification of the corresponding attribute value specification 1312 in a single instance while still considered acceptable. For example, the behavioral attribute of rule 1320 is the distance between the eyes of a viewer and the media the viewer focuses on. If the media is TV, according to its spatial specification 1312, the rule states that for healthy viewing, the eyes of a viewer must be away from the TV screen with a distance of at least 4 times the diagonal width of the TV screen. According to its temporal specification 1314, the rule further requires that a viewer may be less than 4 times the screen width away from the TV screen but for no more than 10 seconds each time. Rule 1320 also specifies the acceptable distance of eyes from a PC monitor screen and that from paper sheets as the media wherein the meaning of the rule is self-explanatory. As another example, rule 1322 defines the head pose as an attribute of a healthy viewing behavior. The rule states that the head pan of a viewer should not exceed 45 degrees for more than 10 seconds, that the head title should not exceed 60 degrees for more than 10 seconds, and that the head roll should not exceed 30 degrees for more than 10 seconds. Similarly. Rule 1324 defines the shoulder pose as an attribute of a healthy viewing behavior. The rule states the shoulder pan should not exceed 15 degrees for more than 5 seconds, and the same for shoulder roll.

FIG. 12B illustrates more exemplary viewing behavior rules each with one specification field 1316. Rule 1326 specifies that room lighting has to be at least 100 lux for viewing TV shows, at least 200 lux for viewing on PC monitor screen and at least 500 lux for reading and writing on paper. Rule 1328 specifies that the longest single session for viewing on TV screen, on PC monitor screen and on paper are 1 hours, 45 minutes and 30 minutes, respectively. Rule 1330 requires a break between viewing sessions should be at least 5 minutes long. Rule 1332 specifies that a viewer should watch TV for no more than 4 hours, viewing on PC monitor screen for no more 2 hours and read/write on paper for no more than 4 hours during a single day. Similarly, rule 1334 specifies that a viewer should watch TV for no more than 12 hours, viewing on PC monitor screen for no more than 10 hours and read/write on paper for no more than 20 hours. Rule 1336 requires a viewer must not violate any viewing behavior rule for more than 5 times total during a single session. Similarly, rules 1338 and 1340 require a viewer must not violate any viewing behavior rule for more than a total of 10 and 20 times, during a single day and during a single week, respectively.

FIG. 13 illustrates a table of exemplary penalizing viewing behavior policies each recorded as a row of the table labeled 1420 through 1440. Each row has two fields 1410 and 1412 where field 1410 identifies the viewing behavior rule that is violated, and field 1412 specifies the actions that a media viewer health care system performs on the viewer who violates the rule. The system performs the specified actions 1412 on a viewer as soon as it determines the viewer has violated the rule identified in field. The actions 1412 generally discourage the viewer from further violation of viewing behavior rules. As an example, according to policy 1420, when the media viewer health care system determines that a viewer has violated the distance rule 1420, it issues a reminder to the viewer and increments the violation count of the viewer by 1 every 5 seconds until the viewer observes distance rule 1420. The reminder is to notify the viewer of the violation of the respective rule. According to one embodiment, the reminder may be a voice message, visual message, a tactile message such as physical vibration at a specific frequency pattern or a combination of such messages. As another example, when room lighting level is too low according to the specification of behavior viewing rule 1426, policy 1426 becomes active so that the system issues a reminder to the viewer of the need to increase the room lighting level perhaps by turning on some lights, and if the lighting level is not increased to at least the specified level of rule 1426 in 15 seconds after the reminder is issued, the system increments the rule violation count of the viewer by 1. As another example, policy 1428 becomes active if a viewer has violated per-session viewing duration rule 1428 for which the system issues a reminder to the viewer. Moreover, if the viewer has been watching TV and continues for 15 minutes after the reminder is issued, the system will power down the TV, or if the viewer has been viewing PC monitor screen and continues for 15 minutes after the reminder is issued, the system will lock the PC monitor screen. Both powering down a TV screen and locking a PC monitor screen may be embodied in various ways as will be discussed in conjunction with FIG. 16 and FIG. 17 illustrating the viewing policy enforcing process 1600.

FIG. 14 illustrates a table of two exemplary rewarding viewing policies each recorded as a row wherein a policy becomes active when a viewer obeys by a particular viewing behavior rule as specified in field 1510 and the system performs the actions specified in field 1512. More particularly, policy 1532 specifies that when a day ends and a viewer has not used up the allowable amount of viewing time for that day, i.e., the viewer obeys by rule 1332 for the day, the system transfers half of the unused viewing time to the viewer's allowable amount of viewing time for the subsequent day. Similarly, policy 1534 specifies that when a week ends and a viewer has not used up the allowable amount of viewing time for the week, i.e., the viewer obeys by rule 1334 for the week, the system transfers a quarter of the unused viewing time to the viewer's allowable amount of viewing time for the subsequent week.

Optionally, the specification of a viewing behavior rule and the respective viewing policies may be made age dependent. For example, the viewing duration per session rule 1228 may be customized so that it allows a specific viewing duration per session that is appropriate for each age group. The age of a viewer may be optionally determined as described in the exemplary viewer behavior evaluation system 100 in conjunction with FIG. 9. Again, it should be noted the foregoing viewing behavior rules and policies are set forth for illustrative purpose only and should not be construed as limiting in any manner.

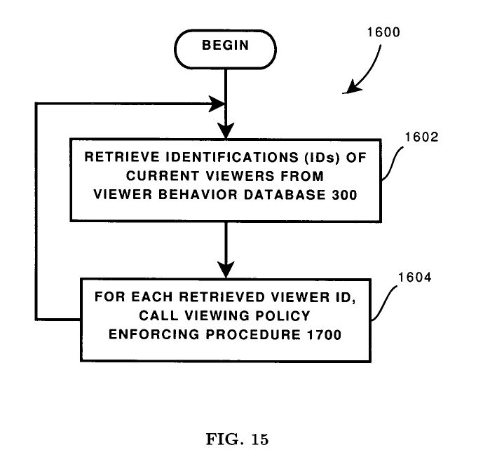

FIG. 15 is a flow chart illustrating the exemplary viewing policy enforcing process 1600. As outlined before, the goal of this process is to check if the viewing behavior of a viewer as determined by viewer behavior tracking process 400 violates or obeys by the viewing behavior rules defined in viewing policy database 1300 and to execute the actions of any viewing policies found applicable on the viewer. As shown in the figure, the exemplary viewing policy enforcing process 1600 iterates once initialized. During each iteration, it first retrieves the identifications (IDs) of viewers that are currently viewing the media in step 1602. Then in step 1604, for each current viewer, it calls viewing policy enforcing procedure 1700.

FIG. 16 is a flow chart illustrating the exemplary viewing policy enforcing procedure 1700 that determines the applicability of all viewing polices relevant to a given media viewer and then executes the actions of applicable policies by invoking a viewing policy execution procedure 1800 illustrated in FIG. 17. A relevant viewing policy for a media viewer becomes applicable if the viewing behavior of the viewer satisfies the condition of the viewing policy wherein the condition is satisfied if the policy is penalizing as illustrated in FIG. 13 and the viewing behavior of the media viewer violates the viewing behavior rule specified by the policy as illustrated in field 1310 or if the policy is rewarding as illustrated in FIG. 14 and the viewing behavior of the media viewer observes the viewing behavior rule specified by the policy as illustrated in field 1410.

As shown in FIG. 16, the viewing policy enforcing procedure 1700 begins by receiving the ID of a media viewer in step 1702. Next, it retrieves from the viewing policy database 1300 all viewing policies relevant to the media viewer in step 1704, and retrieves from the viewer behavior database 300 the evaluated viewing behavior of the media viewer in step 1706. Next, in step 1708, for each retrieved viewing policy, the procedure first evaluates whether the retrieved viewing behavior of the media viewer satisfies the condition of the policy and then stores the evaluation result back to viewer behavior database 300 under the ID of the media viewer for future reference. In step 1710, for each retrieved viewing policy, the viewing policy execution procedure 1800 described below in FIG. 17 is called on the viewer to perform the actions of the policy if it becomes applicable to the viewer. The procedure then returns to the caller.

FIG. 17 is a flow chart illustrating the viewing policy execution 1800. The procedure starts by receiving the ID of a media viewer and a viewing policy ID in step 1802. Next, it retrieves from the viewer behavior database 300 the evaluation result of the said viewing policy which, for example, in the context of the viewing policy enforcing procedure 1700, is determined in step 1708. The result is checked in step 1806. If the behavior of the media viewer does not satisfy the condition of the viewing policy, the procedure returns to the caller without executing the viewing policy.

If, however, the viewing behavior of the viewer satisfies the condition of the viewing policy, the procedure executes the action of the viewing policy in step 1808. For example, if the media viewer is watching a TV program on a TV set with a screen measuring 25 inches in diagonal width, and that the viewing policy refers to the media distance policy 1420 which is assumed to be relevant to the viewer. If, according to the retrieved evaluation result of viewing policy 1420 in step 1804, the condition of the viewing policy is satisfied, i.e., the media viewer violates the distance rule 1220 wherein the media viewer is less than 4×25, i.e., 100 inches away from the TV screen for more than 10 seconds, the test in step 1806 passes. In that case, the procedure executes the action specified in field 1412 for policy 1420. i.e., issues a reminder to the viewer and increments the violation count of the viewer every 5 seconds until the viewer is at least 100 inches away from the TV screen so that distance rule 1220 is observed. Generally, the execution of the action of a viewing policy may be embodied as a separate process that keeps records of the execution history of the action of the policy. For instance, to execute the action of the distance policy 1420 above, a timer may be employed to measure the time elapsed since the last reminder is issued to the viewer.

According to one aspect of the invention, the media viewing health care system 100HC may enforce personalized viewing behavior rules and polices thanks to the viewing identification capability of the system. Based on the unique viewer ID, a human supervisor may customize certain viewing behavior rules and polices for the viewer in the viewing policy database 1300. Again based on the unique viewer ID, the viewing policy enforcing procedure 1700 in step 1704 will accordingly retrieve all viewing policies from the viewing policy database 1300 defined for the viewer.

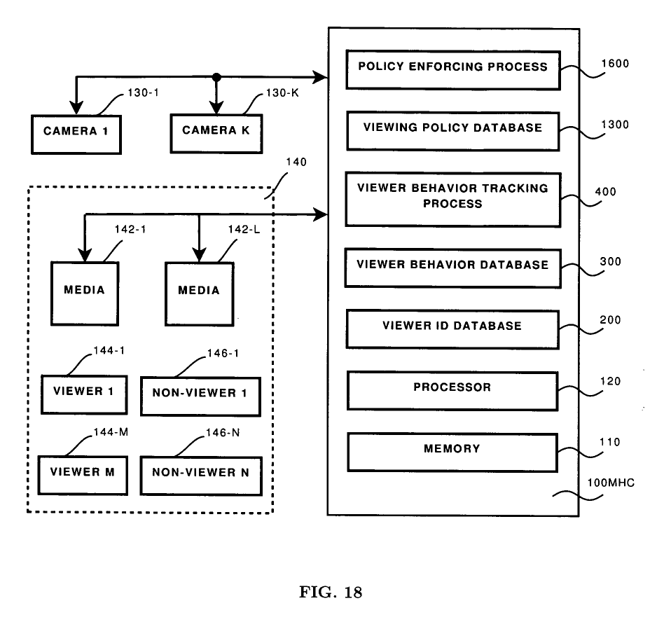

In another embodiment, a media viewer behavior evaluation system 100 may be extended to monitor viewing space of multiple media as illustrated in FIG. 18 referred to as media viewer health care system 100MHC wherein the system monitors L media 142-1 through 142-L with the image capturing devices 130 covering the viewing space of all L media 140. In one embodiment, the same principle of evaluating viewing behavior of viewers of one media described thus far is repeatedly applied on all L media for each set of images acquired by the image capturing devices 130. As the processing power per dollar of integrated circuit products such as the GeForce® graphics processors from nVidia Corporation continues to rise rapidly, a key advantage of such an extended media viewer health care system 100MHC is cost reduction. For example, one media viewer health care system 100MHC may be deployed in a classroom to monitor the reading, writing and sitting postures of all students in the classroom.

Based on the basic principle of delivering health care feature to media viewers using machine vision techniques illustrated above, there can be numerous other variations of the media viewer health care system 100HC. For example, a media viewer health care system 100HC may be natively integrated with a media device such as a PC, a TV set and a game console wherein the media viewer health care system 100HC and the native functionality of the media device are co-designed. One advantage of this approach is cost reduction through sharing of needed computing resource and packaging. Another advantage of this approach is the convenience and flexibility in executing the actions of those viewing policies that need take control of the media device such as powering down the media device, locking the screen if the media device is a PC monitor, or switching the channel if the media device is a TV set.

For a media viewer health care system 100HC that is not natively integrated with a media device, suitable external control of the media device may be employed in executing the actions of viewing policies that need take control of the media device such as those discussed in the proceeding paragraph. For example, for a TV set equipped with a user remote controller, a health care system 100HC may employ remote signaling compatible to the user remote controller in order to control the TV set. Most TV set manufacturers publish the remote signaling codes used in their TV set models. Remote signaling codes may also be learned directly from a remote controller using techniques such as taught in U.S. Pat. No. 6,097,309 issued to Hayes et al. (August 2000). If the media device is a PC, the health care system 100HC may communicated with the PC directly to execute the actions of viewing policies that need take control of the PC whereby the communication may be realized by establishing a convenient connection between the system and the PC such as one based on a bluetooth or an Ethernet networking protocol.

Similarly a media viewer health care system 100HC may control a non-media device to execute the action of a viewing policy. For example, the non-media device may be a study lamp which the health care system may turn on automatically through wired or wireless signaling to enforce a room lighting rule such as the example rule 1226.

It is to be understood that the embodiments and variations shown and described herein are merely illustrative of the principles of this invention and that various modifications may be implemented by those skilled in the art without departing from the scope and spirit of the invention.

What is claimed is:

1. A method for automatically monitoring viewing behavior of at least one viewer of at least one information media, comprising:
acquiring at least one image of the viewing space of said media;
analyzing said image to detect viewers of said media;
analyzing said image to evaluate viewing behavior of said detected viewers if any.

2. A method of claim 1, further comprising:
classifying a detected viewer by analyzing said images.

3. A method of claim 2 whereas said classification of a detected view is performed by at least one of:
estimating the age of said viewer;
recognizing said viewer as an individual;
tracking said viewer;
locating said viewer in physical space;
identifying the media the said viewer visually focuses on.

4. A method of claim 1 whereas said viewing behavior comprises at least one of:
distance between eyes of said viewer and said media;
angle between gaze direction of said viewer and said media;
time said viewer spends viewing said media;
body posture of said viewer;
lighting condition of the surrounding of said viewer and said media;
content on said media viewed by said viewed.

5. A method of claim 4 whereas said lighting condition is measured using at least one of:
analyzing said image;
analyzing signals from at least one light sensing device.

6. A method of claim 1, further providing at least one of said viewers a health care feature based on said analyzed viewing behavior.

7. A method of claim 6 whereas a said health care feature enforces at least one viewing policy.

8. A method of claim 7 whereas said viewing policy comprising:
a health-concerning rule on viewing behavior.

9. A method of claim 8 whereas said viewing policy comprising at least one of:
a real-time or delayed action on said media viewer if said rule is violated;
a real-time or delayed action on said media viewer if said rule is observed.

10. A method of claim 9 whereas said action comprises at least:
a discouraging reminder to said viewer;
an encouraging reminder to said viewer.

11. A method of claim 10 whereas said reminder comprises at least one of:
a visible feedback;
an audible feedback;
a tactile feedback;
a tangible feedback of other forms.

12. A method of claim 9 whereas said action comprising at least one of:
restricting use of said media;
relaxing use of said media.

13. A system for automatically monitoring viewing behavior of at least one viewer of at least one information media, comprising at least:
a memory for storing machine readable code;
a computing machine whereas said machine:
acquires at least one image of the viewing space of said media;
analyzes said image to detect viewers of said media;
analyzes said image to evaluate viewing behavior of said detected viewers if any.

14. A system of claim 13, further comprising:
classifying a detected viewer by analyzing said images.

15. A system of claim 14 whereas said classification of a detected view is performed by at least one of:
estimating the age of said viewer;
recognizing said viewer as an individual;
tracking said viewer;
locating said viewer in physical space;
identifying the media the said viewer visually focuses on.

16. A system of claim 13 whereas said viewing behavior comprises at least one of:
distance between eyes of said viewer and said media;
angle between gaze direction of said viewer and said media;
time said viewer spends viewing said media;
body posture of said viewer;
lighting condition of the surrounding of said viewer and said media;
content on said media viewed by said viewer.

17. A system of claim 16 whereas said lighting condition is measured using at least one of:
analyzing said image;
analyzing signals from at least one light sensing device.

18. A method of claim 13, further providing at least one of said viewers a health care feature based on said analyzed viewing behavior.

19. A method of claim 18 whereas a said health care feature enforces at least one viewing policy.

20. A method of claim 19 whereas said viewing policy comprising:
a health-concerning rule on viewing behavior.

21. A method of claim 20 whereas said viewing policy comprising at least one of:
a real-time or delayed action on said media viewer if said rule is violated;
a real-time or delayed action on said media viewer if said rule is observed.

22. A method of claim 21 whereas said action comprises at least:
a discouraging reminder to said viewer;
an encouraging reminder to said viewer.

23. A method of claim 22 whereas said reminder comprises at least one of:
a visible feedback;
an audible feedback;
a tactile feedback;
a tangible feedback of other forms.

24. A method of claim 21 whereas said action comprising at least one of:
restricting use of said media;
relaxing use of said media.

25. An article of manufacture automatically monitoring viewing behavior of at least one viewer of at least one information media, comprising:
a machine readable medium having machine readable code means embodied thereon, said machine readable code means comprising:
a step to acquire at least one image of the viewing space of said media;
a step to analyze said image to detect a viewer of said media;
a step to analyze viewing behavior of said detected viewer if any.

26. An article of claim 25, further comprising:
a step to provide a health care feature for said viewer based on said analyzed viewing behavior.
